(19) United States
(12) Patent Application Publication
(10) Pub. No.: US 2013/0031240 A1
(43) Pub. Date: Jan. 31, 2013

(54) Capacity Evaluation of Computer Network Capabilities

(71) Applicant: Jeffrey Byzek, Cary, NC (US)

(72) Inventor: Jeffrey Byzek, Cary, NC (US)

(73) Assignee: CISCO TECHNOLOGY, INC., San Jose, CA (US)

(21) Appl. No.: 13/193,827

(22) Filed: Jul. 29, 2011

(51) Int. Cl. G06F 15/173

(52) U.S. Cl. 709/224

(57) ABSTRACT

A method and apparatus are provided for evaluating the capacity of a capability enabled by network devices in a computer network. The method includes identifying a network capability enabled by one or more network devices, monitoring a plurality of hardware resources of the one or more network devices during implementation of one or more instances of the identified network capability and capturing respective device-specific metrics representative of a utilization level of each of the plurality of hardware resources during implementation of the one or more instances. The method also includes identifying which one of the plurality of hardware resources is most limiting for a remaining capacity of the identified network capability, calculating, based on the hardware resource that is most limiting for the remaining capacity of the identified network capability, a maximum remaining capacity for additional instances of the identified network capability, and providing an indication of the maximum remaining capacity of the identified network capability.

### TECHNICAL FIELD

The present disclosure relates to the evaluation of the remaining capacity of capabilities enabled by one or more network devices in a computer network.

### BACKGROUND

Network devices are hardware and/or software components that facilitate or mediate the transfer of data in a computer network. Network devices include, but are not limited to, routers, switches, bridges, gateways, hubs, repeaters, firewalls, network cards, modems, line cards, Channel Service Unit/Data Service Unit (CSU/DSU), Integrated Services Digital Network (ISDN) terminals and transceivers.

A computer network has certain capabilities that are enabled by various combinations of network devices within the network. The ability of the computer network to support these capabilities, referred to as network capacity, is limited by the hardware resources of the network devices. Limiting hardware resources include, but are not limited to, various combinations of input/output (I/O) resources, processing resources, memory, etc.

### BRIEF DESCRIPTION OF THE DRAWINGS

FIG. 1 is a schematic diagram illustrating a computing enterprise having a capacity evaluation module.

FIG. 2 is a schematic diagram illustrating a cloud service provider utilizing a capacity evaluation module.

FIG. 3 is a block diagram of an example capacity evaluation module.

FIG. 4 is a flowchart illustrating a method for evaluating the remaining capacity of a network capability.

### DESCRIPTION OF EXAMPLE EMBODIMENTS

### Overview

A method and apparatus are provided for evaluating the capacity of a capability enabled by network devices in a computer network. The method includes identifying a network capability enabled by one or more network devices, monitoring a plurality of hardware resources of the one or more network devices during implementation of one or more instances of the identified network capability and capturing respective device-specific metrics representative of the utilization level of each of the plurality of hardware resources during implementation of the one or more instances. The method also includes identifying which one of the plurality of hardware resources is most limiting for a remaining capacity of the identified network capability, calculating, based on the hardware resource that is most limiting for the remaining capacity of the identified network capability, the maximum remaining capacity for additional instances of the identified network capability, and providing an indication of the maximum remaining capacity of the identified network capability.

### Example Embodiments

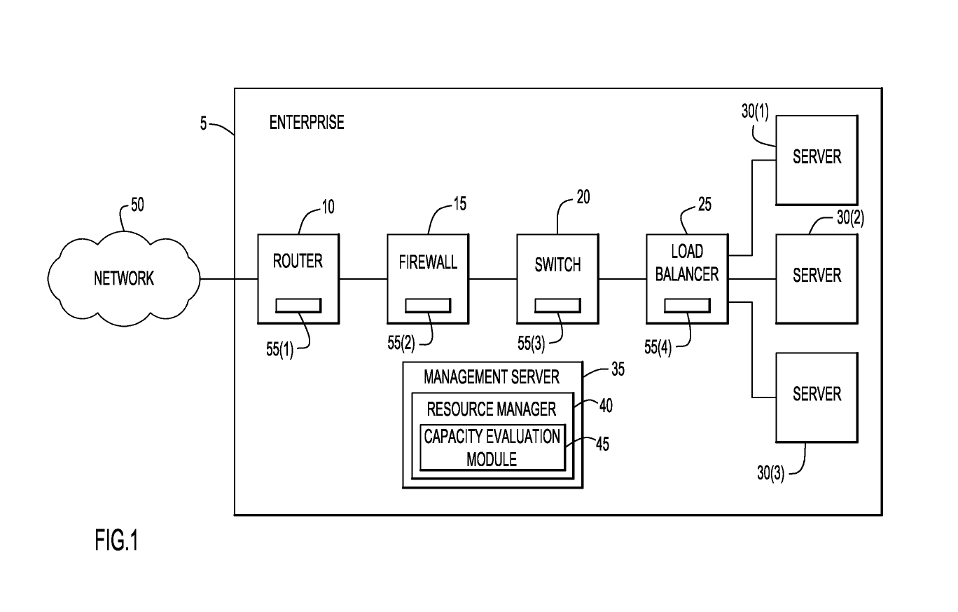

FIG. 1 is a schematic diagram illustrating a computing enterprise 5 comprising a router 10, firewall 15, switch 20, load balancer 25, a plurality of servers 30(1)-30(3), and a management server 35. Management server 35 includes a resource manager 40 having a capacity evaluation module 45.

As previously noted, computer networks have certain capabilities that are enabled by various combinations of network devices. One specific such capability enabled by the enterprise 5 is connections or links between a client device or server, such as servers 30(1)-30(3), and network 50. Network 50 may be a local area network (LAN), wide area network (WAN), etc. Such links are referred to herein as “customer connections” because the links connect a customer (server or client) to the network 50.

In the example of FIG. 1, the network devices enabling these customer connections are router 10, firewall 15, switch 20 and load balancer 25. Router 10 is a network device that functions as the edge device between enterprise 5 and network 50. That is, router 10 is the device that receives data packets from, or forwards data packets to, other devices over network 50. Firewall 15 is a hardware or software component designed to prevent certain communications based on network policies. For ease of illustration, firewall 15 is shown as a hardware component that is separate from router 10. However, it is to be appreciated that firewall 15 may be implemented as dedicated software or hardware in router 10.

Also shown in FIG. 1 is switch 20 that uses a combination of hardware and/or software to direct traffic to different destination devices. Load balancer 25 is a device that distributes workload across servers 30(1)-30(3). For ease of illustration, load balancer 25 is shown as a hardware component that is separate from switch 20. However, it is or be appreciated that load balancer 25 may be implemented as dedicated software or hardware in switch 20.

Router 10, firewall 15, switch 20 and load balancer 25 collectively enable the customer connections. However, the number of supported customer connections is limited by, for example, the I/O resources, processing resources, memory, etc., of the network devices. Generally, multiple customer connections may be simultaneously supported by network devices and each enabled customer connection is referred to as a single customer connection instance. The maximum number of supported customer connection instances is referred to as the maximum customer connection capacity.

Individuals that oversee and manage the operation of segments of a computer network, such as enterprise 5, are referred to as network operators. Network operators may have little insight into the remaining scalability or remaining capacity of the various capabilities enabled by their managed network devices, but operators may have access to device-specific metrics (e.g., percentage of I/O bandwidth utilized, percentage of processing power utilized, bytes of memory consumed, etc.) that represent the utilization level of hardware resources. Such metrics are may not be easily understood by all network operators, and can signify something different for different types of network devices, for different network topologies, and for different network capabilities of interest. For example, a residential broadband service providing basic Internet access will have different resource utilizations and configurations than a business virtual private network (VPN) connecting multiple enterprise sites. This is especially true for a network capability that is supported by a plurality of network devices and hence uses multiple different hardware resources during implementation. In such cases, a device-specific metric that represents the utilization level of a particular hardware resource does not necessarily correlate to the remaining capacity of the particular capability. Accordingly, proper understanding of what a device-specific metric means to the remaining capacity of a specific capability generally forces the operator to understand, for example, specific parameters of each involved network device, the network topology, etc.

In the example of FIG. 1, resource manager 40 on management server 35 includes capacity evaluation module 45 that enables a network operator to more easily determine the remaining capacity of a network capability. In particular, capacity evaluation module 45 is a network management tool that allows the correlation of the obtainable device-specific metrics representing the utilization levels of hardware resources with customer-focused metrics representing the remaining capacity of a specific capability. This allows the network operator to predict how the network will respond to the addition of instances of a particular capability and accordingly tailor the resources of specific network device. Additionally, it relieves the operator from obtaining (often-costly) platform specific knowledge to understand the correlations between capabilities and hardware resources for every device, or combination of devices, in the network. This also allows operators to use real-time data for capacity planning, instead of referencing generic device data and/or testing results that do not account for the operator's specific managed architecture and topology.

Capacity evaluation module 45 is a management interface that may allow the calculation of current values of a specified network capability (i.e., How much of the capability am I currently using?), determination of the remaining available capacity for scaling of one or more network capabilities on the current hardware profile (i.e., How much of a capability is still available?), and determination of hardware configurations needed to meet specified thresholds of a capability (e.g., How much memory would I need to store 2M prefixes?).

Capacity evaluation module 45 may be configured as a network management station (NMS) software tool that includes a query application program interface (API). The capacity evaluation module 45 implements methods via software agents 55(1)-55(4) on the different network devices to monitor and capture device-specific metrics relating to resource utilization. These captured device-specific metrics are used by capacity evaluation module 45 to generate the customer-focused metrics that provide the network operator with an understanding of the remaining capacity of the network to support additional instances of one or more capabilities.

In one form, a particular network capability is identified at capacity evaluation module 45. As described further below, this identification may include receiving a query from a network operator, may occur in response to a specific network condition, etc. Capacity evaluation module 45 monitors hardware resources of the network devices that are utilized during implementation of the particular network capability (using agents 55(1)-55(4)), and captures at least one device-specific metric representative of the utilization level of each of the hardware resources (also using agents 55(1)-55(4)). Capacity evaluation module 45 then identifies or determines which one of the hardware resources is most limiting for the remaining capacity of the identified network capability. In other words, capacity evaluation module 45 determines which of the hardware resources will be first fully utilized upon expansion of the network capability. This “full” utilization may be determined with respect to the maximum capacity of the hardware resource, or with respect to a predetermined threshold that should not be exceeded. Capacity evaluation module 45 then uses this information to generate a customer-focused metric representing the maximum remaining capacity for additional instances of the network capability, and provides an indication of the maximum remaining capacity to the network operator. Further details of the operation of capacity evaluation module 45 are provided below.

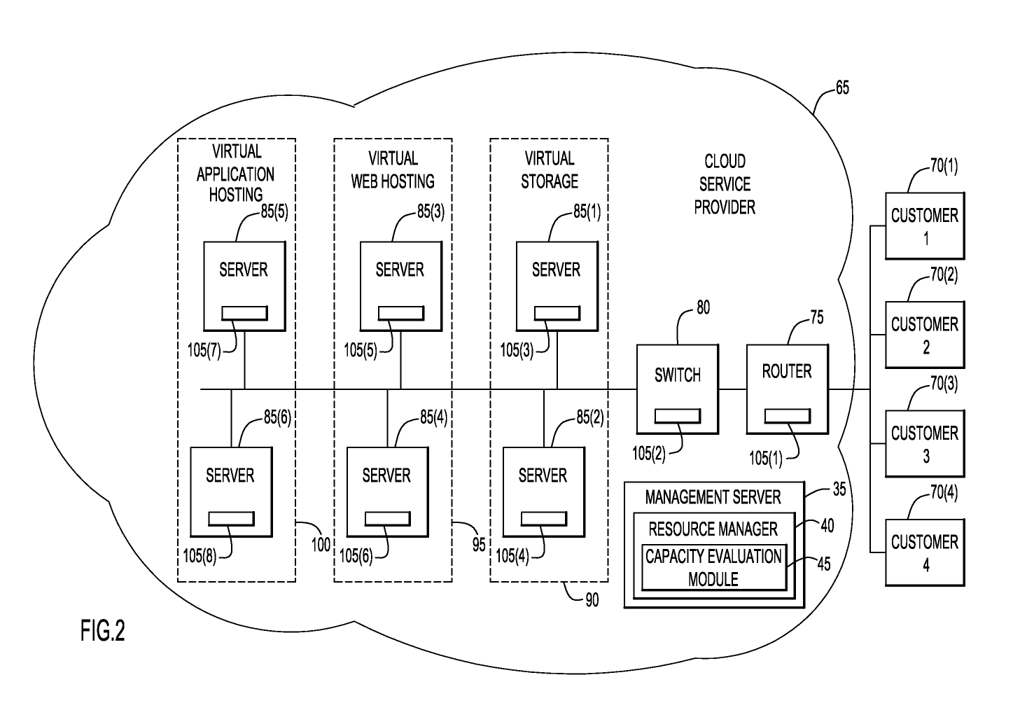

The example of FIG. 1 has been described with reference to a customer connection and, as such, the method for determining the remaining capacity of this specific capability may involve multiple network devices. It is to be appreciated that aspects described herein have applicability to individual network devices (switches, routers, firewalls, load balancers and servers), or for larger constructs within a network, such as a service provider point of presence (PoP) (e.g., to allow a provider to understand capacity at a platform-specific level to determine when upgrades are desired), within a data center (e.g., to calculate when more storage is desired), and, as described below with reference to FIG. 2, within a cloud.

FIG. 2 is a schematic diagram illustrating a computer network comprising cloud service provider 65 and a plurality of customers 70(1)-70(4). Cloud service provider 65 uses a router 75, switch 80, a management server 35, and hosts a plurality of servers 85(1)-85(6). Management server 35 includes a resource manager 40 having a capacity evaluation module 45 as described above with reference to FIG. 1.

As previously noted, computer networks have certain capabilities that are enabled by various combinations of network devices. One such capability specifically enabled by the cloud service provider 65 is the ability to connect or link customers 70(1)-70(4) to the resources hosted by cloud service provider. In the example of FIG. 2, cloud service provider 65 hosts several virtual resources, including virtual storage 90 (servers 85(1) and 85(2)), virtual web hosting 95 (servers 85(3) and 85(4)) and virtual application hosting 100 (servers 85(5) and 85(6)). Servers 85(1)-85(6) may be real or virtual servers.

In one form, customers 70(1)-70(4) may each be a computing enterprise, such as enterprise 5 described above with reference to FIG. 1, having multiple connections to cloud service provider 65. That is, in one form, each customer 70(1)-70(4) includes multiple client devices or servers that access one or more of virtual storage 90, virtual web hosting 95, or virtual application hosting 100. In another form, customers 70(1)-70(4) may each be a client device or server that accesses one or more of virtual storage 90, virtual web hosting 95, or virtual application hosting 100. The connections between customers 70(1)-70(4) and cloud service provider's hosted resources are referred to as customer connections. That is, with respect to a cloud computing environment, a customer connection is a link between a customer and resources (e.g., virtualized storage, compute resources, etc.) hosted by the cloud service provider. The customer connections occur over, for example, a local area network (LAN), wide area network (WAN), etc.

In the example of FIG. 2, the customer connections are enabled by network devices, namely router 75, switch 80 and/or servers 85(1)-86(6). However, the number of supported customer connections is limited by, for example, I/O resources, processing resources, memory, etc., of these devices. Generally, multiple customer connections may be simultaneously supported by cloud service provider 65, and each enabled customer connection is referred to as a single customer connection instance.

The operation of cloud service provider 65 may be managed by a network operator. However, as noted above with respect to enterprise 5 of FIG. 1, network operators may only have access to device-specific metrics that provide limited insight into the remaining scalability or remaining capacity of the various capabilities, such as customer connections, enabled by their managed network devices. As previously noted, such device-specific metrics are generally not easily understandable by all network operators, and can signify something different for different types of network devices, for different network topologies, and for different network capabilities of interest. This is particularly true in a cloud computing environment such as shown in FIG. 2 because the different resources (90, 95 and 100) hosted by cloud service provider 65, when accessed by customers 70(1)-70(4), employ different combinations of network device hardware resources for proper implementation. For example, a customer using the cloud to host a video game server will have a different use of resources compared to a customer using the cloud to host a web server.

Capacity evaluation module 45 in resource manager 40 of management server 35 is provided to enable a network operator to more easily determine the remaining capacity of a capability enabled by the devices of cloud service provider 65. As noted above with reference to FIG. 1, capacity evaluation module 45 is a network management tool that allows the correlation of device-specific metrics representing the utilization levels of hardware resources with customer-focused metrics representing the remaining capacity of a specific capability. In the cloud environment of FIG. 2, this allows the network operator to use the customer-focused metric to determine if the resources in the cloud are sufficient for a customer's demands. As such, the network operator can readily determine if upgrades to the cloud infrastructure are desired.

Capacity evaluation module 45 may be configured as a NMS software tool that includes a query API. In the example of FIG. 2, capacity evaluation module 45 implements methods via software agents 105(1)-105(8) on router 75, switch 80 and servers 85(1)-85(6) to monitor and capture device-specific metrics relating to resource utilization. These captured device-specific metrics may be used by capacity evaluation module 45 to generate customer-focused metrics that provide the network operator with an understanding of the remaining capacity of the network to support additional instances of one or more capabilities.

In one form, a particular network capability is identified at capacity evaluation module 45. This identification may include receiving a query from a network operator, may occur in response to a specific network condition, etc. Capacity evaluation module 45 monitors one or more hardware resources of the devices that are utilized during implementation of the particular network capability (using agents 105(1)-105(8)), and captures at least one device-specific metric representative of the utilization level of the hardware resources (also using agents 105(1)-105(8)). Capacity evaluation module 45 then identifies or determines which one of the hardware resources is most limiting for the remaining capacity of the identified network capability. Capacity evaluation module 45 then uses this information to generate a customer-focused metric representing the maximum remaining capacity for additional instances of the network capability, and provides an indication of the maximum remaining capacity to the network operator. Further details of the operation of capacity evaluation module 45 are provided below.

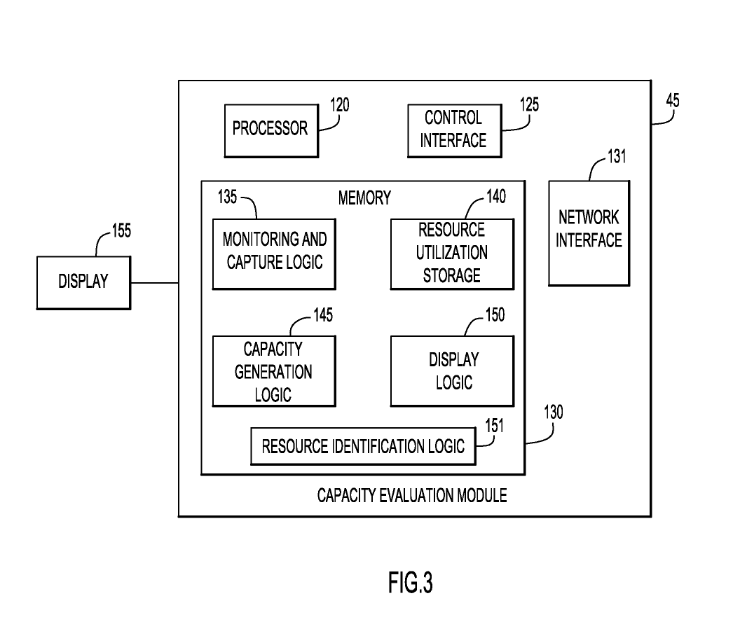

FIG. 3 is a schematic diagram illustrating further details of capacity evaluation module 45. As shown, capacity evaluation module 45 comprises a processor 120, control interface 125, memory 130, and a network interface 131. Memory 130 comprises monitoring and capture logic 135, resource utilization storage 140, capacity generation logic 145, display logic 150 and resource identification logic 151. Capacity evaluation module 45 operates with a display 155.

In operation, processor 120 implements monitoring and capture logic 135 to monitor the utilization level of hardware resources of one or more network devices in a computing environment, such as enterprise 5 or cloud computing environment 60, described above with reference to FIGS. 1 and 2, respectively. More specifically, the monitoring and capture may be performed by, for example, software processes or agents that reside on the different network devices. In one example, processor 120 may query the different software processes for information at a specific time, in response to a query received from another device or network operator, or in response to a specific event, etc. Processor 120 communicates with different network devices and/or software processes via network interface 131 over a network, such as a LAN, WAN, etc.

Subsequently, processor 120 implements capacity generation logic 145 to transform the captured device-specific metrics into a customer-focused metric that represents the remaining capacity or scalability of a particular network capability. More specifically, capacity generation logic 145 implements methods that use the device-specific metrics to generate a second metric that does not represent the utilization of hardware resources, but rather represents the remaining capacity of a network capability.

Processor 120 may then implement display logic 150 to provide an indication of the maximum remaining capacity of the identified network capability at display 155. Display 155 may comprise, for example, a computer, mobile device, etc., that is directly attached, or remotely coupled to, management server 35.

Capacity evaluation module 125 also comprises a control interface 125. Control interface 125 may be configured to allow a network operator or other user to query capacity evaluation module 45 for the remaining capacity of specific network capabilities. Control interface 125 may comprise, for example, a command-line interface (CLI), a graphical user interface (GUI), text user interface (TUI), etc. Control interface 125, although shown as part of capacity evaluation module 45 in FIG. 3, may be at least partially implemented on a separate device in communication with resource manager 40.

As shown in FIG. 3, memory 130 further comprises resource utilization storage 140. In certain circumstances described below, captured device-specific metrics, customer focused metrics, or pre-tested metrics may be stored in resource utilization storage 140 for subsequent access or use.

Aspects may further include determining the configuration of the network devices and/or identifying which hardware resources are used to enable a network capability. As noted elsewhere herein, a network capability of interest is identified, for example, in response to a query by a network operator or a computing device. In certain circumstances, capacity evaluation module 45 may first determine which network devices, and which hardware resources, are used to enable the identified network capability in order to determine the hardware resources to monitor, and what device-specific metrics to capture. In one example, to identify the devices/resources, processor 120 implements resource identification logic 151. The implementation of this logic 151 may include querying software processes or other elements in the network devices, accessing pre-testing information, etc., and may further include an evaluation of the implemented network topology.

Memory 130 may be read only memory (ROM), random access memory (RAM), magnetic disk storage media devices, optical storage media devices, flash memory devices, electrical, optical, or other physical/tangible memory storage devices. Processor 120 is, for example, a microprocessor or microcontroller that executes instructions for monitoring and capture logic 135, capacity generation logic 145, display logic 150, and resource identification logic 151 stored in memory 130. Thus, in general, memory 130 may comprise one or more computer readable storage media (e.g., a memory device) encoded with software comprising computer executable instructions and when the software is executed (by processor 120) it is operable to perform the operations described herein in connection with monitoring and capture logic 135, capacity generation logic 145, display logic 150, and resource identification logic 151.

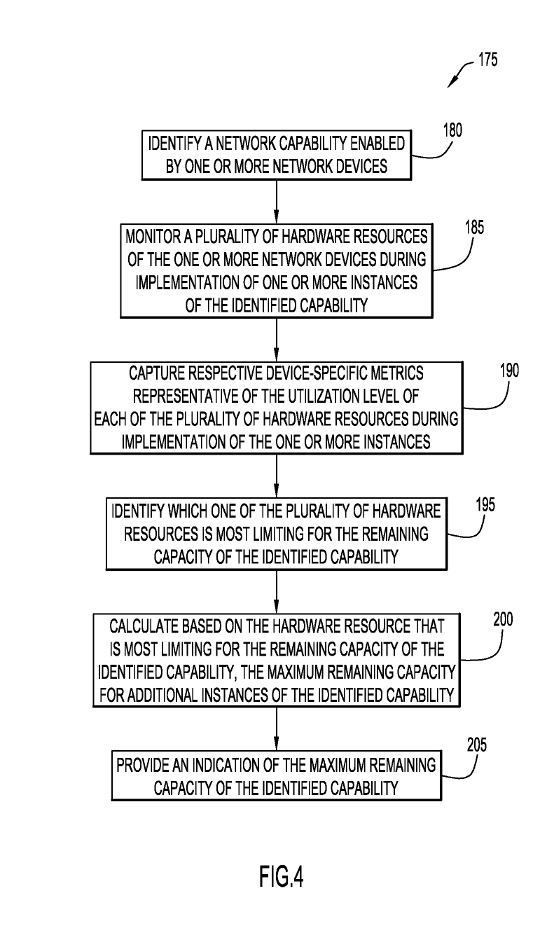

FIG. 4 is a high-level flowchart of a method 175 that may be implemented by the capacity evaluation module in the examples of FIG. 1 or FIG. 2. Method 175 begins at 180 wherein a network capability enabled by one or more network devices is identified. As noted above, there are a number of different network capabilities that may be of interest and thus identified. Also as noted, this identification may occur at a specific time, in response to a specific event, or in response to a request or query received from a network operator to other user via a control or user interface.

Method 175 continues at 185 with the monitoring of a plurality of hardware resources of the one or more network devices utilized during implementation of one or more instances of the identified network capability. At 190, respective device-specific metrics representative of the utilization level of each of the plurality of hardware resources during implementation of the one or more instances is captured. Furthermore, at 195, the one of the hardware resources that is most limiting for the remaining capacity of the identified network capability is identified (i.e., which of the hardware resources will be fully utilized first upon expansion of the network capability). At 200, using the most limiting of the hardware resources, the maximum remaining capacity for additional instances of the network capability, is calculated, and an indication of the maximum remaining capacity of the network capability is provided at 205.

The remaining capacity of a computer network may be evaluated in terms of a number of different network capabilities. Example capabilities that may be evaluated include, but are not limited to, customer connections, Border Gateway Protocol (BGP) bestpaths stored in a router, subscribers, BGP neighbors, mobile data connections, video streams, etc. It is to be appreciated that this list of network capabilities is merely illustrative and other network capabilities may be evaluated using techniques described herein.

The following is a description illustrating the evaluation of customer connections in a computer enterprise, such as enterprise 5 of FIG. 1. In this example, a customer connection uses a number of different hardware resources. The resources may be common to all network interfaces (a “centralized” forwarding model) or there may be sets of network interfaces on independent line cards (LCs) that have their own subset of resources (a “distributed” forwarding model). The resources utilized may include Network Processor (NP) bandwidth (in bits per second), NP packet/frame throughput (in packets per second), NP forwarding table memory, LC processor usage, LC processor memory, LC interconnect (“switch fabric”) bandwidth and interface queues (typically implemented in hardware application-specific integrated circuits (ASICs)). The impact of a customer connection can be fully described in terms of these resources. In one form, the router would include a data structure to store resource utilization for each of the customer connections to use as a basis for capacity evaluation calculations by capacity evaluation module 45.

As previously noted, evaluation capacity module 45 may utilize software processes implemented on the specific network devices to monitor hardware resources and/or capture device-specific metrics representative of the utilization level of the hardware resources. The following provides examples for capturing device-specific metrics representative of the utilization levels of specific hardware resources. In these examples, the usage is captured in terms of average utilization per customer. It is to be appreciated that other measurements could also be taken to determine the peak utilization, rather than average utilization per customer.

I/O resources utilized in this example may include input link bandwidth (ILB), output link bandwidth (OLB), Input uplink bandwidth (IUB), and output uplink bandwidth (OUB). The utilization levels of each of these resources may be derived in different manners. For example, the ILB usage may be derived from the statically configured permitted input traffic rate on an attached interface, or from the average measured interface input rate over a fixed period of time. Similarly, OLB usage may be derived from the statically configured permitted output traffic rate on the attached interface, or from the average measured interface output rate over a fixed period of time. IUB usage may be derived from the statically configured permitted input traffic rate on the attached interface, or from the average measured interface input rate over a fixed period of time. OUB usage may be derived from the statically configured permitted output traffic rate on the attached interface, or from the average measured interface output rate over a fixed period of time

Control plane processor usage may be derived from vendor testing that defines a specific processor utilization value for the control plane element based on configured protocols and features. Alternatively, control plane processor usage may be derived from monitoring overall processor utilization over a fixed period of time, subtracting non-customer-related process utilization from the monitored processor utilization, and dividing by the number of active customer connections. If no hardware-based network processor exists, the processor utilization also includes the effort to process packets traversing the customer connection by measuring the number of packets per second.

Control plane element processor memory (CEM) usage can also be determined from vendor testing that defines a specific memory utilization value per prefix for all processes that are impacted by prefixes learned on that customer connection: routing information base (RIB), forwarding information base (FIB), label table, BGP database, OSPF database, flow sampling cache, etc. Alternatively, control plane element processor memory may be determined from monitoring overall memory utilization over a fixed period of time, subtracting non-customer-related process utilization there from, and dividing by the number of active customer connections.

Input NP packet/frame processing utilization (INPPU) may be derived by measuring the number of packets offered to the NP in the input direction for a particular customer connection over a fixed period of time. Similarly, output NP packet/frame processing utilization (ONPPU) may be derived by measuring the number of packets offered to the NP in the output direction for a particular customer connection over a fixed period of time. Input NP forwarding table utilization (INPFT) may be derived by measuring the memory on the Input NP used only by prefixes that were learned across the customer connection, while output NP forwarding table utilization (ONPFT) may be derived by measuring the memory on the output NP used only by prefixes that were learned across the customer connection.

LC processor usage (LCCPU) may be derived from vendor testing that defines a specific LC processor utilization value for the LC processor based on configured protocols and features. Alternatively, LC processor usage may be derived from monitoring overall LC processor utilization over a fixed period of time, subtracting non-customer-related process utilization there from, and dividing by the number of active customer connections. If no hardware-based NP exists, the LC processor utilization also includes the effort to process packets traversing the customer connection by measuring the number of packets per second.

LC processor memory (LCM) usage may be derived from vendor testing that defines a specific memory utilization value per prefix for all the processes impacted by prefixes learned on that customer connection: FIB, flow sampling cache, etc. LC processor memory usage may also be derived by monitoring overall memory utilization over a fixed period of time, subtracting non-customer-related process utilization there from, and dividing by the number of active customer connections. Input interface queues (IIQ) may be found by counting the number of input interfaces queues allocated to the customer connection, while output interface queues (OIQ) may be found by counting the number of input interfaces queues allocated to the customer connection. Input/Output NP (INPB, ONPB) and LC interconnect bandwidth (ILCIB, OLCIB) may reuse the same values as defined by the Input/Output interface link bandwidth or, if hardware capabilities exist to filter on a particular customer connection, can be measured at the NP/interconnect level by examining the traffic rates over a fixed period of time.

As noted above, after capturing the relevant device-specific metrics, the device-specific metrics are transformed into customer-focused metrics that represent the remaining capacity for addition of customer connections. Example steps for this transformation are provided below.

First, the impact of a single customer connection is calculated as shown below in Equation (1).

CC₁=a₁(ILB)+b₁(OLB)+c₁(CECPU)+d₁(CEM)+e₁(INPPU)+f₁(ONPPU)+g₁(INPFT)+h₁(ONPFT)+i₁(LCCPU)+j₁(LCM)+k₁(IQ)+l₁(OQ)+m₁(INPB)+n₁(ONPB)+o₁(ILCIB)+p₁(OLCIB)+q₁(IUB)+r₁(OUB) Equation (1)

Next, as shown below in Equation (2), the aggregate impact of all customer connections is calculated.

CC_{1 . . . n}=a_{1 . . . n}(ILB)+b_{1 . . . n}(OLB)+c_{1 . . . n}(CECPU)+d_{1 . . . n}(CEM)+e_{1 . . . n}(INPPU)+f_{1 . . . n}(ONPPU)+g_{1 . . . n}(INPFT)+h_{1 . . . n}(ONPFT)+i_{1 . . . n}(LCCPU)+j_{1 . . . n}(LCM)+k_{1 . . . n}(IQ)+l_{1 . . . n}(OQ)+m_{1 . . . n}(INPB)+n_{1 . . . n}(ONPB)+o_{1 . . . n}(ILCIB)+p_{1 . . . n}(OLCIB)+q_{1 . . . n}(IUB)+r_{1 . . . n}(OUB) Equation (2)

As shown below in Equation (3), the utilization for an average customer connection is then calculated by dividing the aggregate impact by the number of connections.

CCₓ=CC_{1 . . . n}/n Equation (3)

As shown below in Equation (4), to determine remaining capacity of the capability, an entry wise subtraction of the aggregate customer connection values from the maximum resource values is performed.

$${CC}_{rem} = ( {a}_{max} - {a}_{1 … n} ) ( ILB ) + ( {b}_{max} - {b}_{1 … n} ) ( OLB ) + ( {c}_{max} - {c}_{1 … n} ) ( CECPU ) + ( {d}_{max} - {d}_{1 … n} ) ( CEM ) + ( {e}_{max} - {e}_{1 … n} ) ( INPPU ) + ( {f}_{max} - {f}_{1 … n} ) ( ONPPU ) + ( {g}_{max} - {g}_{1 … n} ) ( INPFT ) + ( {h}_{max} - {h}_{1 … n} ) ( ONPFT ) + ( {i}_{max} - {i}_{1 … n} ) ( LCCPU ) + ( {j}_{max} - {j}_{1 … n} ) ( LCM ) + ( {k}_{max} - {k}_{1 … n} ) ( IQ ) + ( {l}_{max} - {l}_{1 … n} ) ( OQ ) + ( {m}_{max} - {m}_{1 … n} ) ( INPB ) + ( {n}_{max} - {n}_{1 … n} ) ( ONPB ) + ( {o}_{max} - {o}_{1 … n} ) ( ILCIB ) + ( {p}_{max} - {p}_{1 … n} ) ( OLCIB ) + ( {q}_{max} - {q}_{1 … n} ) ( ILB ) + ( {r}_{max} - {r}_{ 1 … n} ) ( OLB ) \qquad Equation ( 4 )$$

As shown below in Equation (5). This value is then used to determine the number of remaining customer connections the network device is able to support by dividing the remaining resources by the utilization of an average customer, and subsequently determining which resource is the first to be consumed. More specifically, Equation (5) is used to evaluate each of the resources to determine which resource will be consumed or exhausted first. This first consumed resource is the limiting factor in the maximum remaining capacity or, in other words, the maximum number of customer connections that can be added.

# remaining=CCᵣₑₘ/CCₓ Equation (5)

The above example relates to network devices in a computing enterprise. Another example of mapping device-specific resources to customer-focused metrics involves the cloud, where an operator of a cloud infrastructure wants to know how many more customers can be provisioned with respect to existing network resources. This correlates to, for example, the arrangement of FIG. 2 to determine the number of additional customers that may be supported by the cloud. In this example, the same methodology as described above in the previous example is used, except with three distinctions. First, in this cloud example, the uplink bandwidth (traffic that moves in and out of the cloud) is distinguished from traffic that moves back and forth within the cloud. Second, since a single customer may request multiple virtual machines connected to different nodes in the network, the calculations noted above are performed across multiple devices. Alternatively, the request may use multiple types of network resources, like a firewall or load balancer, in addition to network bandwidth. Third, when calculating an average customer connection, virtual machines that use primarily in/out (north-south) bandwidth are distinguished from and those that use primarily within-the-cloud (east-west) bandwidth. This correlation is done by measuring which type of traffic the connection predominately generates. The main distinction in terms of calculating remaining capacity for customer connections is that instead of being limited by the scarcest resource on a single device, the limit is now based on the scarcest resource from multiple devices.

By measuring usage (which comprises not just bandwidth, but also, for example, processing resources and packet buffers during congestion) and correlating the times and types of applications with the levels of usage, a precise vision of the overall network load may be calculated. For example, consider a cloud service hosting web servers, SQL servers, and hadoop clusters. When each web server is brought online, it signals the network to begin monitoring usage patterns of hardware resources in different devices. By taking an average over the course of a period of time (e.g., day, week, month), each network device is able to calculate its mean, minimum and maximum loads for the servers, as well as an average profile for all web servers. Using this information, the operator can understand how network resources relate to customers and plan accordingly. If a new web server customer wishes to be hosted in the cloud, the operator can query the network for current usage and, for example, plan to buy a new firewall if he notices that an additional web customer would push him beyond his comfortable threshold for hardware resources.

A Border Gateway Protocol (BGP) router typically receives multiple paths to the same destination and a BGP bestpath methodology that determines the best path to install in the IP routing table and to use for traffic forwarding. Another capability enabled by a computer network is the storage of such bestpaths in the router. The number of BGP bestpaths that may be stored is limited by the resources consumed by the BGP bestpaths, which, in this example, comprise route processor memory (Mrp), line card memory (Mlc), and hardware ASIC forwarding memory (Mhw).

As noted above, the device-specific metrics for each of Mrp, Mlc and Mhw may represent the utilization levels of the resources, but do not always provide a network operator with knowledge regarding the remaining capacity of the capability that uses these resources (i.e., the remaining number of BGP bestpaths than can be stored). As noted above, aspects described herein implement a method that uses these device-specific metrics to provide the operator with the customer-focused metric of the remaining capacity for storage of BGP bestpaths.

In a first iteration of an example method, the worst-case values for each resource, determined by pre-release testing, may be used. By way of example, it is assumed that testing established following usage for each resource: 1024 Mrp, 256 Mlc, and 64 Mhw. These numbers can then be used to establish the number of BGP bestpaths that may be added before one of the resources is consumed, or crosses a predetermined or user-defined threshold. It is assumed that a particular device has the following amounts of remaining resources: 2 million Mrp, 1 million Mlc, and 64K Mhw. Based on free Mrp, the device can hold (2 million/1024) or 1,935,125 more bestpaths, while based on free Mlc, the device can hold (1 million/256) or 3,906,250 more bestpaths. However, based on free Mhw, the device can hold (64K/64) or 1 million more bestpaths. The lowest remaining resource is the limiting factor for the number of bestpaths that be added (i.e., free Mhw at 1 million).

Additionally, the calculation can be used to set thresholds of a resource that is triggered when usage crosses that line. Thresholds define an acceptable value or value range for a particular variable. When a variable exceeds a policy, an event is said to have taken place. Events are operational irregularities that the network operation would like to know about before service is affected. For example, the operator may desire to be notified when the device can only hold 250,000 more bestpaths. From above, it is known that 250,000 bestpaths use the following amount of resources: 256,000,000 Mrp (1024×250000); 64,000,000 Mlc (256×250000); and 16,000,000 Mhw (65×250000). The network device can then be configured to notify the operator when the values of these resources fall below the above values. However, as noted, instead of configuring the notification mechanism in terms of the resources themselves, it is done in terms of remaining capacity (i.e., notify when the number of remaining bestpaths falls below 250,000).

The use of the remaining capacity allows further refinement of the method. For example, the method may be refined to add additional resources into the calculation (e.g., add processor usage), adjust the method to look at, for example, prefix length, or to separate out resource utilization by process (e.g., BGP vs. RIB vs. FIB), among other refinements. Refinements can be incremental as development resources permit, thus the precision of the capacity evaluation may become more granular over time. For example, an initial implementation considers only processor memory, allowing for detailed modeling of control plane scaling, nut perhaps not data plane scaling. As more resources are added to the equation, both the number of scale factors and overall accuracy of the calculation increases.

In another example, resource utilization is monitored and a history of the utilization that is specific to the device is used. More specifically, in the BGP bestpath example, instead of simply asserting that each bestpath uses a certain amount of memory based on worst-case values from pre-release testing, the actual usage of resources by the bestpaths is monitored as they are added to the system. This approach may be advantageous in this specific bestpaths example because the device's existing prefix distribution may influence the actual amount of memory each bestpath uses. In a more general sense, this approach ensures customization as the amount of resources consumed by a capability is generally not uniform across all instances. As an example, this approach is used for Mhw. It is assumed that pre-tested values indicate that the usage is 64/bestpath. However, it is also assumed that historical sampling gives a minimum usage of 16/besthpath, a maximum of 256/bestpath, and an average of 56/bestpath. New calculations using these values give the number of bestpaths at 4,000,000 for the minimum value (64000000/16) (i.e., remaining free Mhw divided by the minimum resource consumed for each bestpath), at 250,000 for the maximum value 64000000/256), and at 1,142,857 for the mean value (64000000/56). Providing the number of bestpaths available based on the minimum, maximum and mean consumption to an operator allows the operator to inspect all values and plan accordingly.

The above description is intended by way of example only.

What is claimed is:

1. A method comprising:
identifying a network capability enabled by one or more network devices;
monitoring a plurality of hardware resources of the one or more network devices during implementation of one or more instances of the identified network capability;
capturing respective device-specific metrics representative of a utilization level of each of the plurality of hardware resources during implementation of the one or more hardware instances;
identifying which one of the plurality of hardware resources is most limiting for a remaining capacity of an identified network capability;
calculating, based on the hardware resource that is most limiting for the remaining capacity of the identified network capability, a maximum remaining capacity for additional instances of the identified network capability; and
providing an indication of the maximum remaining capacity of the identified network capability.

2. The method of claim 1, wherein identifying which one of the plurality of hardware resources is most limiting for the remaining capacity of the identified network capability comprises:
determining an average utilization of each of the plurality of hardware resources for a single instance of the identified network capability;
obtaining a number of current instances of the identified network capability;
obtaining a total acceptable capacity for each of the plurality of hardware resources; and
for each of the plurality of hardware resources, using the average utilization, the number of current instances, and the total acceptable capacity to determine the most limiting hardware resource for maximum remaining capacity.

3. The method of claim 2, wherein determining the average utilization of the plurality of hardware resources for a single instance of the identified network capability comprises:
computing a utilization level of each of the plurality of hardware resources resulting from implementation of a singe instance of the identified network capability;
computing an aggregate utilization level of each of the plurality of hardware resources as a result of all current instances of the identified network capability; and
dividing the aggregate utilization level of each of the plurality of hardware resources by the number of current instances of the identified network capability.

4. The method of claim 1, wherein monitoring the plurality of hardware resources of the one or more network devices utilized during implementation of one or more instances of the identified network capability comprises:
monitoring input-output (I/O) resources of the one or more network devices.

5. The method of claim 1, wherein monitoring the plurality of hardware resources of the one or more network devices utilized during implementation of one or more instances of the identified network capability comprises:
monitoring processing resources of the one or more network devices.

6. The method of claim 1, wherein monitoring the plurality of hardware resources of the one or more network devices utilized during implementation of one or more instances of the identified network capability comprises:
monitoring memory resources of the one or more network devices.

7. The method of claim 1, wherein calculating a maximum remaining capacity for additional instances of the identified network capability comprises:
calculating the maximum remaining capacity with respect to a pre-determined threshold.

8. The method of claim 1, wherein identifying a network capability enabled by one or more network devices comprises:
identifying a network capability in response to a request received from a control interface.

9. An apparatus comprising:
at least one network interface for connection to one or more network devices; and
a processor configured to:
identify a network capability enabled by the one or more network devices;
monitor, via the network interface, a plurality of hardware resources of the one or more network devices during implementation of one or more instances of the identified network capability;
capture respective device-specific metrics representative of a utilization level of each of the plurality of hardware resources during implementation of the one or more instances;
identify which one of the plurality of hardware resources is most limiting for a remaining capacity of the identified network capability;
calculate, based on the hardware resource that is most limiting for the remaining capacity of the identified network capability, a maximum remaining capacity for additional instances of the identified network capability; and
provide an indication of the maximum remaining capacity of the identified network capability.

10. The apparatus of claim 9, wherein to identify which one of the plurality of hardware resources is most limiting for the remaining capacity of the identified network capability, the processor is further configured to: determine an average utilization of each of the plurality of hardware resources for a single instance of the identified network capability; obtain a number of current instances of the identified network capability; obtain a total acceptable capacity for each of the plurality of hardware resources; and, for each of the plurality of hardware resources, use the determined average utilization, the number of current instances, and the total acceptable capacity to determine the most limiting hardware resource for maximum remaining capacity.

11. The apparatus of claim 10, wherein to determine the average utilization of the plurality of hardware resources for a single instance of the identified network capability, the processor is further configured to: compute a utilization level of each of the plurality of hardware resources resulting from implementation of a singe instance of the identified network capability; compute an aggregate utilization level of each of the plurality of hardware resources as a result of all current instances of the identified network capability; and divide the aggregate utilization level of each of the plurality of hardware resources by the number of current instances of the identified network capability.

12. The apparatus of claim 9, wherein to monitor the plurality of hardware resources of the one or more network devices utilized during implementation of one or more instances of the identified network capability the processor is configured to monitor input-output (I/O) resources of the one or more network devices.

13. The apparatus of claim 9, wherein to monitor the plurality of hardware resources of the one or more network devices utilized during implementation of one or more instances of the identified network capability the processor is further configured to monitor processing resources of the one or more network devices.

14. The apparatus of claim 9, wherein to monitor the plurality of hardware resources of the one or more network devices utilized during implementation of one or more instances of the identified network capability the processor is further configured to monitor memory resources of the one or more network devices.

15. The apparatus of claim 9, wherein to identify a network capability enabled by one or more network devices the processor is configured to identify a network capability in response to a request received from a control interface.

16. One or more computer readable storage media encoded with software comprising computer executable instructions and when the software is executed operable to:
identify a network capability enabled by one or more network devices;
monitor a plurality of hardware resources of the one or more network devices during implementation of one or more instances of the identified network capability;
capture respective device-specific metrics representative of a utilization level of each of the plurality of hardware resources during implementation of the one or more instances;
identify which one of the plurality of hardware resources is most limiting for a remaining capacity of the identified network capability;
calculate, based on the hardware resource that is most limiting for the remaining capacity of the identified network capability, a maximum remaining capacity for additional instances of the identified network capability; and
provide an indication of the maximum remaining capacity of the identified network capability.

17. The computer readable storage media of claim 16, wherein the instructions operable to identify which one of the plurality of hardware resources is most limiting for the remaining capacity of the identified network capability comprise instructions operable to:
determine an average utilization of each of the plurality of hardware resources for a single instance of the identified network capability;
obtain a number of current instances of the identified network capability;
obtain a total acceptable capacity for each of the plurality of hardware resources;
for each of the plurality of hardware resources, use the determined average utilization, the number of current instances, and the total acceptable capacity to determine the most limiting hardware resource for maximum remaining capacity.

18. The computer readable storage media of claim 16, wherein the instructions operable to determine the average utilization of the plurality of hardware resources for a single instance of the identified network capability comprise instructions operable to:
compute a utilization level of each of the plurality of hardware resources resulting from implementation of a singe instance of the identified network capability;
compute an aggregate utilization level of each of the plurality of hardware resources as a result of all current instances of the identified network capability; and
divide the aggregate utilization level of each of the plurality of hardware resources by the number of current instances of the identified network capability.

19. The computer readable storage media of claim 16, wherein the instructions operable to monitor the plurality of hardware resources of the one or more network devices utilized during implementation of one or more instances of the identified network capability comprise instructions operable to:
monitor input-output (I/O) resources of the one or more network devices.

20. The computer readable storage media of claim 16, wherein the instructions operable to monitor the plurality of hardware resources of the one or more network devices utilized during implementation of one or more instances of the identified network capability comprise instructions operable to:
monitor processing resources of the one or more network devices.

21. The computer readable storage media of claim 16, wherein the instructions operable to monitor the plurality of hardware resources of the one or more network devices utilized during implementation of one or more instances of the identified network capability comprise instructions operable to:
monitor memory resources of the one or more network devices.
